(19) United States
(12) Patent Application Publication
(10) Pub. No.: US 2022/0323178 A1
(43) Pub. Date: Oct. 13, 2022

(54) ROOT CANAL INSTRUMENT WITH A VARIABLE PITCH

(71) Applicant: Micro-Mega International, Besançon (FR)

(72) Inventors: Marie DEVALLOIR, Besançon (FR); Marin VINCENT, Lay-Saint-Christophe (FR)

(73) Assignee: Micro-Mega International, Besançon (FR)

(21) Appl. No.: 17/717,185

(22) Filed: Apr. 11, 2022

(30) Foreign Application Priority Data
Apr. 12, 2021 (FR) 2103754

(51) Int. Cl. A61C 5/42; A61C 5/50

(52) U.S. Cl. CPC A61C 5/42; A61C 5/50

(57) ABSTRACT

The invention relates to a root canal instrument (10) having a blade comprising a plurality of helical cutting edges (20), the blade being conical in shape and extending from a tip (11) towards a mandrel (12) of the instrument, the helical edges (20) having a pitch increasing along a longitudinal axis of the instrument from the tip (11) towards the mandrel (12).

According to the invention, it comprises a ratio between the pitch at the mandrel (12) and the pitch of the end of the tip (11), of between 2 and 4.

### RELATED APPLICATION

This application claims the benefit of priority of France Patent Application No. 2103754 filed on Apr. 12, 2021, the contents of which are incorporated herein by reference in their entirety.

### FIELD AND BACKGROUND OF THE INVENTION

The invention relates to the technical field of dentistry, and in particular to instruments used in root canal treatment.

Instruments dedicated to root canal treatment have helical cutting edges whose role is to remove debris from the root canal of the tooth to be treated. When root canal instruments are used according to a continuous movement, the edges are permanently active. That is to say, they are continuously cutting through the tissue or material in the root canal of the tooth during the rotational movement, and the helical shape of the edges causes the debris to ascent and be removed from the tooth. However, this continuous rotation may result in a screwing or suction sensation that may be uncomfortable for both the patient and the practitioner.

Also, some medical practices involve using the instrument in an alternating, or reciprocal, rotational movement, in which the instrument is first driven in an first direction of rotation that corresponds to the cutting direction of the helical lips, and then in an opposite direction of rotation in which the cutting edges are inactive, i.e. not cutting. This return movement reduces or even eliminates the screwing or suction sensation. Such uses are widely described in the state of the art, despite their major disadvantage in that they slow down debris removal produced by the cutting action.

Indeed, when rotating in the opposite direction, the debris is brought back down into the channel instead of being brought up.

In order to facilitate the removal of the debris, it may be possible to manufacture root canal instruments, such as files or reamers, provided with helically shaped cutting lips, the geometric parameters of which changing along the instrument.

For example, document WO2005/089370 describes a file with varying edge pitch along its length. Tables 1, 2 and 3 together with FIGS. 5(a) to 7(b) show files with increasing pitch from the tip of the file to the mandrel. However, the changing pattern of the pitch is unsatisfactory in terms of debris removal.

Patent EP2485675, owned by the applicant and whose description is included here by reference, describes a root canal reamer in which the changing pattern of the geometric parameters of the edges leads to a modification of the number of edges along the length of the instrument. For example, the instrument has three edges at its tip and two edges at its mandrel. Although the files described in this document include an auxiliary and non-cutting edge in the middle portion of the file, which helps to lift debris from the canal, these files may be further improved.

### SUMMARY OF THE INVENTION

One of the aims of the invention is to overcome the above-mentioned disadvantages by designing a root canal instrument which can be used reciprocally while ensuring satisfactory removal of debris from the root canal.

For this purpose, a root canal instrument has been designed and developed having a blade comprising a plurality of helical cutting lips, the blade being conical in shape and extending from a tip of the instrument towards a mandrel of the instrument, the helical edges having a pitch increasing along a longitudinal axis of the instrument from the tip towards the mandrel.

According to the invention, the root canal instrument comprises a ratio between the pitch at the mandrel and the pitch at the tip, of between 2 and 4.

In this way, the tip of the instrument has a low pitch value, which allows the edges to cut without inducing any significant screwing or suction sensation, whereas the upper part of the instrument, at the mandrel, has a considerably higher pitch value allowing debris to be removed efficiently. The large pitch of the instrument in this area does not lead to any excessive screwing sensation, since it is mainly at the level of the tip of the instrument that this inconvenience appears. Thus, the instrument according to the invention makes it possible to combine a precise cutting at the tip and a significant removal of debris at the mandrel part.

Advantageously, the pitch increases consistently, or continuously, from the tip towards the mandrel, such that there are no sharp edges at the cutting lips, nor any discontinuities in any of the cuts made by them.

In order for the instrument to follow the root canal and operate according to its anatomical shape and characteristics, the edges meet at the tip and form a non-cutting, or non-active, extremity of the root canal instrument. In this way, the instrument is not likely to deviate from the canal and perforate the tooth.

In order to assist the advancement of the instrument within the canal, the non-cutting end has a conical shape with an apex angle of between 60 and 130 degrees, and preferably between 80 and 110 degrees.

In one preferred embodiment, the instrument has a number of helical edges that varies along the longitudinal axis of the lip, and the edge comprises successively, along the longitudinal axis:
an initial portion in which the blade comprises an first number of helical edges having identical first geometrical characteristics at sections orthogonal to the longitudinal axis, along the first portion;
a second portion in which the helical edges have different geometric characteristics from one edge to another, such that at least one of the helical edges is no longer a cutting lip; and
a third portion in which the edge comprises a second number different from the first number of helical lips, and in which the helical edges have identical second geometric characteristics at sections orthogonal to the longitudinal axis along the third portion, the second geometric characteristics being different from the first geometric characteristics. This design makes it possible to take advantage of an auxiliary edge within the second portion whose geometry can be adapted, and in particular with a view to assist the debris removal.

In this embodiment, at least over a part of the second portion, a helical pitch of one edge is different from the helical pitch of the other lips. This makes it possible to take advantage of an auxiliary edge within the second portion whose pitch is adapted to assist in debris removal.

The root canal instrument according to the above-mentioned technical characteristics has a resistance to torsion and/or cyclical fatigue during a treatment simulation, with alternating rotations around its longitudinal axis, on an arc portion in an initial direction that corresponds to the cutting direction of the lips, and then on an arc portion in an opposite direction, with a ratio between the arc portion in the initial direction and the arc portion in the opposite direction that is greater than 2 and lesser than 3. This ratio of arc greater than 2 makes it possible to take advantage of a high degree of cutting performance and debris removal. Limiting its value to lesser than 3, however, avoids inducing any excessive screwing or suction sensation.

Advantageously, the portion of arc in the first direction is 170 degrees and the portion of arc in the opposite direction is 60 degrees, which allows a complete rotation of the instrument in just over 3 turns. The treatment time is not affected.

### BRIEF DESCRIPTION OF THE SEVERAL VIEWS OF THE DRAWINGS

FIG. 1 is a partial front view of an instrument according to the invention.

FIG. 2 is an enlarged view of FIG. 1.

FIG. 3 is a top view of a range of five instruments according to the invention.

FIG. 4 is a graph showing the changing pattern of the helical edge pitch of several instruments according to the invention.

FIG. 5 is a graph showing the changing pattern of the helix angle of helical edges of such instruments.

FIG. 6 is a photograph of an instrument during pre-clinical tests.

### DESCRIPTION OF SPECIFIC EMBODIMENTS OF THE INVENTION

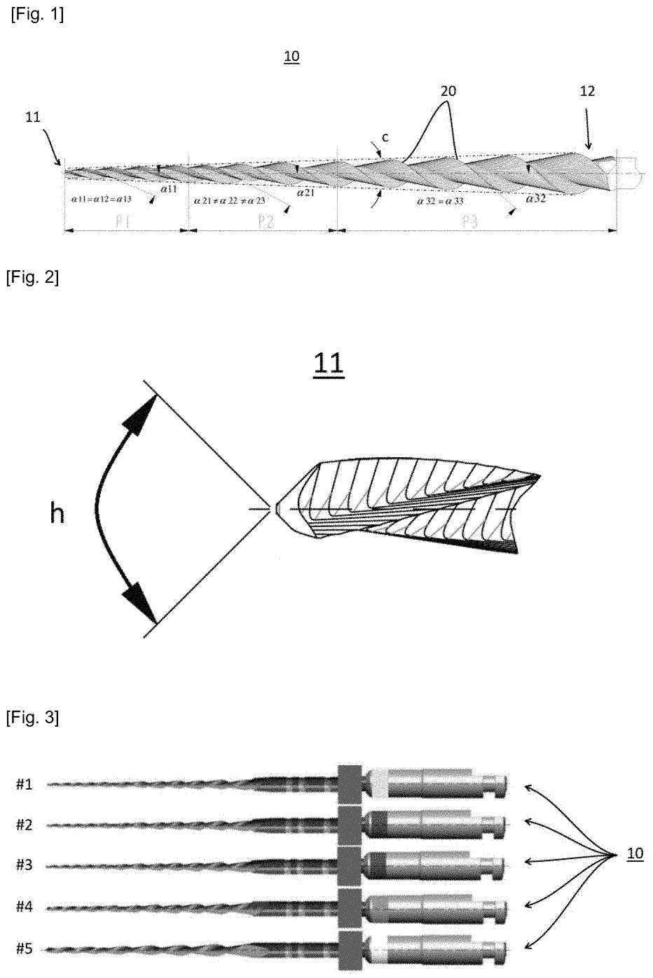

With reference to FIGS. 1 and 2, the invention relates to a root canal instrument (10) comprising a blade, extending from a tip (11) towards a mandrel (12), along a longitudinal axis of the instrument (10). For greater certainty, the rear end of the instrument (10) is not shown and that the various embodiments that may form said mandrel (12) are known to the person skilled in the art and will not be further detailed here.

The blade of the instrument (10) is generally cut from a suitable material such as an alloy of nickel and titanium that is well known under the name of Nitinol, and has a conical shape. This taper (c) is usually expressed as a percentage, and may be fixed. For example, a file may have a taper (c) of between 3% and 8%, or preferably between 4% and 6%. The taper (c) may also be stepped, or change along the length of the lip, such that the edge has a shape approximating that of an ogive, for example. In this document, the term “taper” covers the different types of embodiment.

The blade comprises at least one cutting edge (20), and generally between 2 and 4 cutting edges (20). These edges (20) are helically shaped, such that the cut debris is naturally removed towards the mandrel (12) of the blade when the instrument (10) is rotated in the so-called “active” direction.

If the edges (20) rotate in the “S” direction, also known as left-hand pitch, the active direction of rotation is counter-clockwise. Conversely, if the edges (20) rotate in the “Z” direction, also known as right-hand pitch, the active direction of rotation is clockwise. The choice of rotation direction of the edges (20) does not follow any convention, and may be chosen at will.

According to the invention, the pitch of the edges (20) changes along the blade, so as to guarantee a high degree of both cutting performance and debris removal performance, without however, inducing any unpleasant suction or screwing sensations.

By means of various tests, the applicant has been able to determine that the above-mentioned performances are maximized when a ratio between the pitch at the tip (11) and the pitch at the mandrel (12) is between 2 and 4. For example, for a given size of instrument (10), the pitch at the tip (11) is 1.45 mm and the pitch at the mandrel (12) is 3.5 mm, such that their ratio is 2.41.

The instruments (10) are provided in different sizes in order that the practitioner may select the appropriate instrument (10) according to the size and morphology of the tooth to be treated. For example, within the same range, instruments (10) with a taper (c) of 4% or 6% are available.

Also, in order to comply with the pitch ratio according to the invention, the rotation angles of the edges (20) are adapted along the instrument. As the person skilled in the art knows the geometrical relationship between the pitch, helix angle and diameter of the instrument (10), he/she will know how to make the appropriate cutting according to the nominal diameter of the instrument (10), its fixed or variable taper (c), etc.

FIG. 3 illustrates a range of five instruments (10) according to the invention, made from a wire of a same diameter but having been cut differently. In this figure, from top to bottom:
instrument #1 has a tip diameter of 0.2 mm and a taper (c) of 4%;
instrument #2 has a tip diameter of 0.25 mm and a taper (c) of 4%;
instrument #3 has a tip diameter of 0.25 mm and a taper (c) of 6%;
instrument #4 has a tip diameter of 0.35 mm and a taper (c) of 4%;
instrument #5 has a tip diameter of 0.45 mm and a taper (c) of 4%.

In the preferred embodiment, the instrument (10) has a complex geometry and comprises three cutting edges (20) at the tip (11), which transform such that there are only two cutting edges (20) at the mandrel (12). The instrument (10) thus has a variable cross-section: at the tip (11), the three edges (20) form a triple helix-shaped section, whereas at the mandrel (12) the two edges (20) form an “S” shaped section.

The advantage of varying the number of edges (20) along the instrument (10) is to have a large number of edges (20) at the tip (11), e.g. three, which improves the tendency of the instrument (10) to re-center within the canal as it progresses toward the dental root apex.

Conversely, a reduced number of edges (20) in the upper portion, for example two, allows more latitude to adapt the geometric characteristics of the edges (20), such as the angles of cutting, clearance, or helix, such that the performance of the instrument (10) may be improved at this location and, in particular, ascending the debris towards the tooth crown.

Furthermore, in a second portion (P2) of the instrument (10), at the level of which one of the edges (20) changes so as to disappear progressively, this edge (20) no longer performs a cutting function. Its geometrical characteristics may therefore be adapted in order to assist in ascending the cut debris.

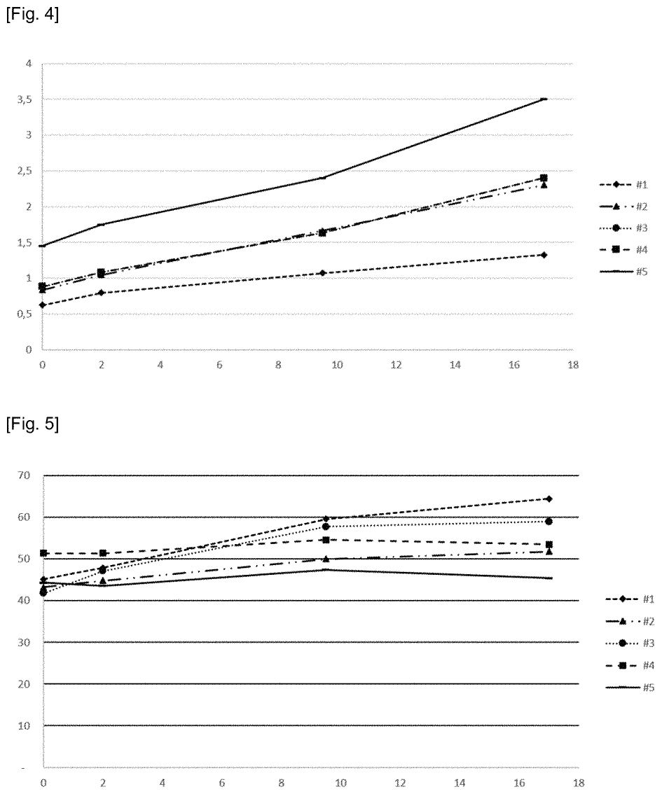

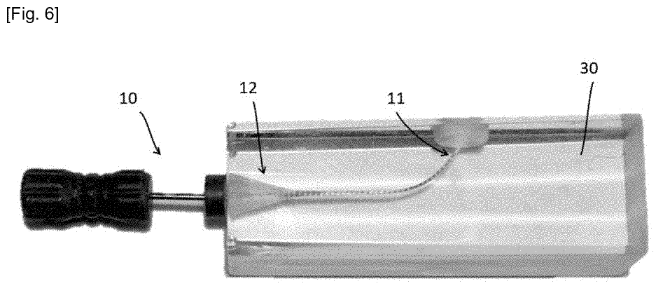

The graph in FIG. 4 shows the changing pattern of the pitch along each instrument (10) of the range. In this graph, the x-axis is the distance from the tip (11) of the instrument (10), and the y-axis is the pitch value. Because the pitch values of instruments #2, #3 and #4 are close, the curves tend to overlap. However, it is clearly visible that the pitch at the mandrel (12) is systematically between double and quadruple the pitch at the tip (11).

The graph in FIG. 5 shows the changing pattern of the helix angle, or edge wrap angle (20), along each instrument (10) of the range. In this graph, the x-axis is the distance from the tip (11) of the instrument (10), and the y-axis is the value of the helix angle. As the relationship between the pitch and helix angle involves also the rotational diameter, the ratio according to the invention is not directly visible on this graph, but the latter serves to illustrate more visibly the changing pattern of the geometric characteristics of the edges (20) along the instrument (10).

Helix angles (α) are also captioned in FIG. 1:
the angles (α11, α12, α13,) are respectively the helix angles of the first, second and third edges (20) at a first portion (P1) of the instrument (10);
the angles (α21, α22, α23,) are respectively the helix angles of the first, second and third edges (20) at the second portion (P2) of the instrument (10);
the angles (α31, α32) are respectively the helix angles of the first and second edges (20) at a third portion (P3) of the instrument (10).

Preferably, the pitch varies continuously along the instrument (10), such that there are no discontinuities on the edges (20). Such discontinuities may result in sharp angles or cusps on the edges (20) which are not desired because they may lead to injury during treatment.

Preferably, the tip (11) of the instrument (10) is non-active, allowing the instrument (10) to follow the natural anatomy of the root canal. If the tip (11) of the instrument (10) were active, there would be a risk of the tip (11) drilling into the tooth in a direction other than the direction of the root canal, thus impeding the treatment process.

The applicant has performed preclinical tests on the use of instruments (10) according to the invention. These tests involve, among other things, simulating the treatment of a tooth, using resin blocks (30) as illustrated in FIG. 5. The use of simulated canals in resin blocks (30) has been widely described in the literature; this model allows a high degree of standardization, and prevents variables that may be caused by differences in anatomy: shape, size, taper, degree, location, radius of curvature and dentin hardness of the extracted teeth.

In vitro evaluation of the performance of the instruments (10) according to the invention on simulators has made it possible to define the optimal conditions of use of the instrument (10). The following parameters were trialed, for example, the:
compliance with the root canal trajectory such as centering or displacement;
counting of other possible manifestations such as stoppages, false routes or root canal perforations;
generation of debris during the shaping of the canal as well as the direction of apical or coronal displacement of the debris;
resistance to cyclical fatigue and torsional fatigue.

It is apparent from the trials performed that the instrument (10) can be used reciprocally. In particular, the best results are obtained by rotating in the active direction by a portion of arc of 170°, and rotating in the opposite direction by a portion of the arc of 60°. Other angle values were tested, in order to give the practitioner the possibility of adjusting the reciprocating movements, if he/she wishes, for example, to further limit the screwing sensation produced by reducing the amplitude of the movement in the active direction of rotation. In general, the tests performed demonstrate that a ratio between the portion of the arc in the active direction and the portion of the arc in the opposite direction must be greater than 2 and lesser than 3.

Although the instrument (10) can be used in different ways, it must be able to withstand:
either continuous rotation, which corresponds to conventional use;
or to a reciprocal rotation defined by a rotation in the active direction of a portion of arc of 170°, and a rotation in the opposite direction of a portion of arc of 60°, which makes it possible to reduce both the suction sensation and risks of breakage, while maintaining a reasonable treatment time.

Withstanding means that the instrument is safe to use (reduced occurrences of breakages), and effective (successful root canal treatment). The withstanding assessed by performing root canal shaping tests with a rotational speed of 300 rpm and a torque of 5 Ncm, in extracted teeth (maxillary molars), or in simulators (resin blocks reproducing a root canal). The withstanding is insufficient if there is a breakage or a plastic deformation of the instrument.

If the instrument (10) must be used at other speeds or torques, for example between 200 rpm and 500 rpm, or at torques between 2 Ncm and 6 Ncm, then the tests may be adapted accordingly.

The geometry and material of the instrument (10) are therefore chosen in order to obtain this withstanding.

In practice, the dynamic of the instrument (10) is adjusted by means of an interface at the handpiece receiving the instrument (10). The interface comprises means for controlling a motor which drives the instrument (10), according to set speeds and, if applicable, angles of reciprocity. The practitioner adjusting the dynamic is required to comply with the information provided by the manufacturer of the instrument (10) in order to prevent any misuse, in which the safety and/or effectiveness of use would not be guaranteed.

The instrument (10) can be shaped differently from figures without getting out from the scope of the invention, which is defined by the claims.

In a variant not shown, the instrument has more than 3 edges (20) at its tip. According to another variant not shown, the number of edges (20) is constant.

Furthermore, the technical characteristics of the various embodiments and variants mentioned above can be combined in their entirety or only in part. Thus, the instrument (10) can be adapted in terms of cost, functions and performance.

What is claimed is:

1. A root canal instrument (10) having a blade comprising a plurality of helical cutting edges (20), the blade being conical in shape and extending from a tip (11) towards a mandrel (12) of the instrument, the helical edges (20) having a pitch increasing along a longitudinal axis of the instrument from the tip (11) towards the mandrel (12) characterized in that it comprises a ratio between the pitch at the mandrel (12) and the pitch of the end of the tip (11), of between 2 and 4.

2. A root canal instrument (10) according to claim 1 characterized in that the pitch increases steadily from the tip (11) towards the mandrel (12).

3. A root canal instrument (10) according to claim 1 characterized in that the edges (20) meet at the tip (11) and form a non-cutting end of the root canal instrument (10).

4. A root canal instrument (10) according to claim 3 characterized in that the non-cutting end has a conical shape with an apex angle (h) of between 60 and 130 degrees, and preferably between 80 and 110 degrees.

5. A root canal instrument (10) according to claim 1 characterized in that a number of helical edges (20) vary along the longitudinal axis of the blade, and the blade comprises successively, along the longitudinal axis:
an first portion (P1) in which the blade comprises an first number of helical edges having identical initial geometrical characteristics at sections orthogonal to the longitudinal axis, along the first portion (P1);
a second portion (P2) in which the helical edges (20) have different geometric characteristics from one edge to another, such that at least one of the helical edges (20) is no longer a cutting lip; and
a third portion (P3) in which the blade comprises a second number different from the first number of helical edges (20), and in which the helical edges (20) have identical second geometric characteristics at sections orthogonal to the longitudinal axis along the third portion (P3), the second geometric characteristics being different from the first geometric characteristics.

6. A root canal instrument (10) according to claim 5 characterized in that, at least over part of the second portion (P2), a helical pitch of one edge (20) is different from the helical pitch of the other edges (20).

7. A root canal instrument (10) according to claim 1, characterized in that it has a resistance to torsion and/or cyclical fatigue during a treatment simulation, with alternating rotations around the longitudinal axis of the instrument (10), on an arc portion in an initial direction that corresponds to the direction of cutting of the lips, and then on an arc portion in an opposite direction, with a ratio between the arc portion in the initial direction and the arc portion in the opposite direction that is greater than 2 and lesser than 3.

8. A root canal instrument (10) according to claim 7, characterized in that the arc portion in the initial direction is 170 degrees and the arc portion in the opposite direction is 60 degrees.
